(19) United States
(12) Patent Application Publication
(10) Pub. No.: US 2004/0229983 A1
(43) Pub. Date: Nov. 18, 2004

(54) Polypropylene and plastomer compositions and method of use thereof in molded products

(76) Inventor: Kris W. Winowiecki, Howell, MI (US)

Correspondence Address: MCLEOD & MOYNE, P.C., 2190 COMMONS PARKWAY, OKEMOS, MI, 48864, US

(21) Appl. No.: 10/437,953

(22) Filed: May 14, 2003

(51) Int. Cl. C08L 1/00

(52) U.S. Cl. 524/127; 524/504; 524/445; 524/444; 524/492; 524/493

(57) ABSTRACT

A composition substantially free of elastomers (plasticizers), which is a crystalline polypropylene homopolymer, modified by mixing with an ethylene octene copolymer plastomer and containing an exfoliated inorganic nanocomposite and a coupling agent which is a polyolefin polymer grafted to maleic anhydride is described. The composition is adapted to be used with pigments to make finished molded products which have an appearance of paint covered by a clear coat and which are scratch resistant.

### BACKGROUND OF THE INVENTION

(1) Field of the Invention

The present invention relates to novel polypropylene homopolymer compositions, without substituted amounts of an elastomer, comprising the polypropylene, a thermoplastic plastomer, an exfoliated nanocomposite and a polyolefin maleic anhydride coupling agent which links the components together. The polypropylene compositions are used with color pigments to produce molded products with a surface which has an appearance of clear-coated paint film.

(2) Description of Related Art

Crystalline polypropylene polymers are well known in the prior art. Isotactic, syndiotactic and atactic forms are described in U.S. Pat. No. 6,300,419 to Sehanobish et al.

Ethylene based plastomers are known in the art and are described for instance in U.S. Pat. No. 6,399,707. There is no suggestion of compositions with nanocomposites which meet automotive standards, without an elastomeric material.

The use of intercalated and exfoliated layered nanocomposites in polymers to increase strength and heat resistance is well known to those skilled in the art. Illustrative are U.S. Pat. No. 4,889,885 to Usuki et al, U.S. Pat. Nos. 5,993,769, 6,261,640, 5,866,645 to Pinnavaia et al, U.S. Pat. No. 6,242,500 to Lan et al, U.S. Pat. Nos. 6,228,903, 6,057,396, 6,287,634, 5,698,624, 5,578,672, 5,552,469 to Beall et al, U.S. Pat. No. 6,271,298 to Powell et al and U.S. Pat. Nos. 6,121,361, 5,973,053, 6,103,817, and 6,126,734 to Usuki et al. U.S. Pat. No. 6,365,661 to Fischer et al, U.S. Pat. No. 5,962,553 to Ellsworth, U.S. Pat. No. 5,952,095 to Beall et al, U.S. Pat. No. 5,952,093 to Nichols, U.S. Pat. No. 5,747,560 to Christian. All of these patents are incorporated by reference.

The automotive industry has worked for decades to increase fuel efficiency of vehicles by replacing a significant amount of steel once used to manufacture vehicles by lighter parts made out of plastic materials. The industry has moved toward recycling components of vehicles in order to reduce consumption of natural resources. Modern thermoplastics have improved physical properties impact strength for a bumper and can be recycled.

While the function of modern thermoplastics have been improved, there still is a need to match the quality of a painted surface in terms of depth of color and gloss. Matching a full color palette has been difficult in the past because of the color palette including metallics and special effect pigments. In addition, the vehicle is expected to have the highest quality of depth of color and high gloss. In the past, exterior body panels have either been painted or laminated with a film in order to match the paint chip. However, there are a number of problems relating to these methods of achieving a good color match: 1) The uneven distribution of the coating film; 2) The VOC given off during the coating process; 3) Cracking of the film at low temperatures; 4) Limited flexibility of the film at low temperatures; and 5) Excess of film during the laminating process, for instance. The present invention provides an exterior molded product for automotive use that matches a paint chip in depth of color and of high gloss without the cost and warranty issues involving the painting or laminating.

U.S. Pat. No. 6,017,989 to Malm et al describes polypropylene modified by an elastomer (plasticizer) which with pigments are used in automotive molded products. The combination in an unpigmented polymer has a haze level of less than 50% as measured by ASTM D-1003-95. Special effects pigments, whether metallic or pearlescent, are described as being particularly suitable for these polypropylene compositions. The problem is twofold: first, the compositions lose stiffness because of the elastomer and second, the elastomer contributes to a softer surface, which is thus more easily scratchable.

### OBJECTS

It is therefore an object of the present invention to provide polypropylene homopolymer compositions which have a very low haze level, which are non-brittle at low temperatures, because of the use of a thermoplastic plastomer, and which have significant strength. It is further an object of the present invention to provide polypropylene compositions which are economical to prepare and which are easily injection moldable. These and other objects will become increasingly apparent by reference to the following description.

### SUMMARY OF THE INVENTION

The present invention relates to a thermoplastic composition substantially free of elastomers which comprises in admixture:

(a) a crystalline polypropylene homopolymer having a haze of less than about 10% and a luminous transmittance of at least about 80% as measured by ASTM D1003 95;

(b) a thermoplastic plastomer which is a linear copolymer of ethylene and an octene monomer wherein a plastomer is present in an amount between about 1 and 10 percent by weight of the polypropylene;

(c) an exfoliated layered inorganic nanocomposite derived from a precursor nanocomposite with nanolayers and galleries between the nanolayers wherein the nanocomposite is present in an amount between about 0.1 and 6% by weight of the composition, wherein the nanocomposite has been exfoliated by (a), (b) or a mixture of (a) and (b);

(d) a coupling agent which is a polyolefin polymer grafted to maleic anhydride and which couples (a), (b) and (c) together in an amount up to about 10% by weight of the composition, wherein the composition when molded without pigments has at least the haze and the luminous transmittance of the polypropylene.

Preferably the composition contains a color pigment. Preferably the composition is as a formed molded product. Preferably the composition is as a body part for a vehicle. Most preferably the composition is as a body part for a vehicle which duplicates a paint color of the vehicle. Preferably the precursor nanocomposite contains an exfoliating agent which is an organic onium ion for exfoliation by (a) and (b). Preferably the nanocomposite has a particle size of between about 1 and 100 microns. Preferably the composition as pellets formable into a molded product. Preferably the precursor nanocomposite is a 2:1 layered silicate with a particle size between about 1 and 100 nanometers and contains an organic quaternary ammonium ion between the layers, which facilitates exfoliation. Preferably the olefin monomer is octene. Also preferably the plastomer is present in an amount less than ten percent (10%) by weight of the composition. Preferably the coupling agent is a polymer linked to maleic anhydride.

The present invention also relates to a method for the preparation of a molded part which comprises:

(a) providing a thermoplastic composition substantially free of elastomers which comprises in admixture:

(i) a crystalline polypropylene homopolymer having a haze of less than about 10% and a luminous transmittance of at least about 80% as measured by ASTM D1003 95;

(ii) a thermoplastic plastomer which is a copolymer of ethylene and an octene monomer in an amount between about 1 and 10 percent by weight of the polypropylene;

(iii) an exfoliated layered inorganic nanocomposite derived from a precursor nanocomposite with nanolayers and galleries between the nanolayers in an amount between about 0.1 and 6% by weight of the composition, wherein the nanocomposite has been exfoliated by (a), (b) or a mixture of (a) and (b); and

(iv) a coupling agent which is a polyolefin polymer grafted to maleic anhydride which couples (a), (b) and (c) together which is present in an amount up to about 10% by weight of the composition, wherein the composition when molded without pigments has at least the haze and the luminous transmittance of the polypropylene; and

(b) forming the molded part, wherein the part without a color pigment has the haze of less than 10% and the luminous transmittance of at least about 80%.

The present invention further relates to a method for forming a thermoplastic composition which comprises:

(a) blending of a mixture

(i) a crystalline polypropylene homopolymer having a haze of less than about 10% and a luminous transmittance of at least about 80% as measured by ASTM D1003 95;

(ii) a thermoplastic plastomer which is a copolymer of ethylene and octene in an amount between about 1 and 10 percent by weight of the polypropylene;

(iii) a coupling agent which is a polyolefin polymer grafted to maleic anhydride which couples (a), (b) and (c) together which is present in an amount up to about 10% by weight of the composition, wherein the composition when molded without pigments has at least the haze and the luminous transmittance of the polypropylene;

with a precursor nanocomposite so that the precursor nanocomposite is exfoliated in a mixture of (i), (ii) and (iii); and

(b) extruding the mixture with the exfoliated nanocomposite and cutting the extrudate to form pellets.

The present invention relates to a recyclable composition which comprises:

a particulate material from a molded product of the thermoplastic composition as previously described which has been ground to provide the composition.

The present invention also relates to a method of recycling a polypropylene composition which comprises:

(a) providing a first molded product of a thermoplastic composition as previously described;

(b) grinding the molded product to a particulate material; and

(c) molding the particulate material into a second molded product.

As used herein the phrase “substantially free” in relation to the elastomer means usually less than one percent (1%) of the total weight of the composition. In a particular embodiment, the amount of elastomer used in the compositions is an amount that does not adversely affect the scratch resistance of the resulting molded product. Preferably, the level, if any, of elastomer is such that the scratch resistance is not reduced. As a general rule, the compositions of the present invention contain about 3% or less, preferably 2% or less, and more preferably 1% or less, the percentages being based on the total weight of the compound. In a preferred application, the compositions contain no elastomers.

As used in the present invention the term “thermoplastic composition” means a thermally formable mixture of the components, which may be in the form of a blend, non-pigmented pellets, pigmented pellets, non-pigmented mold products or pigmented mold products.

The term “molded product” refers to a part which has been subjected to heat and pressure to form an article of manufacture with a distinctive shape.

The thermoplastic compositions of the present invention are substantially free of elastomers. The molded products are flexible and strong. The molded products appear as if they were covered with a conventional paint which had been clear coated in the conventional manner and thus are color matched to such finishes, such as on automobiles. The products are useful in settings where a decorative finish is required.

Thermoplastic compositions are typically sold without the pigment. In the molding plant the pigment is added to the composition and then injection molded in a mold with a very high finish to form the molded product. This method allows the user to change pigments (color compositions) which are stored in relatively small containers. The need for large silos of single color pigmented thermoplastic compositions is thus eliminated.

More specifically, the invention relates to automotive exterior/interior automotive vehicle component such as body side moldings/claddings as well as various interior components such as: A, B, C pillars, and various bezels manufactured with this material and color matched with such pigmentation to perfectly match an automotive exterior and interior paint chips, and a method to recycle such components.

### DESCRIPTION OF PREFERRED EMBODIMENTS

The term “crystalline” means that the polypropylene and the thermoplastic composition have a regular crystal structure which is shown by x-ray diffraction lines. Crystalline polypropylene provides a very good base for the colorants used in the compositions of the present invention.

The term “elastomer” means a rubbery or elastic material. Elastomers are generally polymers containing olefinic unsaturating in the polymer backbone. They are normally prepared as homo-polymers or co-polymers of monomers containing two or more double bonds. Non-limiting examples of such monomers include butadiene and isoprene. Block polymers of butadiene and styrene are commonly used. In general these materials are avoided in the present invention, since they reduce the scratch resistance of the exposed surfaces of the final product.

The term “nucleating agent” means a compound which promotes crystallinity in the polymer. They can also perform the function of clarifying the polymer (See Plastics Technology, page 74 October 1999). Such compounds include aromatic carboxylic acids and their derivatives, e.g. sodium benzoate, aluminum p-tert-butyl benzoate and aluminum benzoate; metal organic phosphates, e.g. sodium di(4-t-butyl phenyl)phosphate and other aromatic phosphates; benzylidine sorbitol derivatives; talc; polyvinyl cycloalkanes, e.g. polyvinyl cyclohexane and organic dicarboxylic acid derivatives, e.g. sibacic acid. These compounds are well known to those skilled in the art as exemplified by U.S. Pat. No. 5,362,782 to McCullough et al, the Amfine Literature and Leaversuch, R. D. et al. 50-53 (August 1998).

The “crystalline polypropylenes” used in the present invention are well known, have a crystal structure and can be prepared and characterized as described in, for instance, U.S. Pat. No. 6,300,419 to Sehanobish et al, which is incorporated herein by reference. Pre-polymerized polypropylene is typically crystallized with a nucleating agent. Typically the melt flow rate by ASTM 1238 is between about 0.1 and 100 grams per 10 minutes for the crystalline polypropylene which is used as a component in the present invention.

Typically the haze level of the crystalline polypropylene used in the present invention is less than 10%, as tested by ASTM D-1003-95. A luminescent transmittance of more than 80% and preferably greater than 90% also measured by ASTM D-1003-95 is also required. The thickness of the test specimen is typically 40 to 60 mils (0.040 to 0.060 inch) for the ASTM test (i.e. a film).

The exfoliated nanocomposite of the present invention is derived from precursor nanocomposite galleries which have been intercalated with the polypropylene homopolymer and plastomer by shear mixing. Such nanocomposites are commercially available and generally contain organic or inorganic compounds in the galleries which are compatible with the polymers being intercalated and which expand upon shear mixing. The preferred nanocomposites contain organic onium compounds in the galleries and are available from Nanocor, Arlington Heights, Ill. as the “P” series for use with polypropylene to increase strength (see P-808 Technical Data). These nanocomposites can be described as surface modified montmorillonite minerals. These are generally classed as 2:1 layered silicates. The use of nanocomposites for strength in polyolefins is described for instance in U.S. Pat. No. 4,889,885. Further, the nanocomposites are described in the U.S. patents cited under Related Art. All of these patents are incorporated herein by reference herein. The nanocomposite preferably has a particle size between 1 and 100 microns.

The coupling agent, which is a polyolefin polymer grafted to maleic anhydride, links the polypropylene, plastomer and nanocomposite together. The result is a polymer composition with flexibility and strength. The bonds can be covalent, ionic or by intermingling. The reactions can be with available hydroxyl (OH) groups in the polypropylene polymers and with functional groups in the nanocomposite. Typically the coupling agent has at least one group which is reactive with the polypropylene, plastomer and/or the nanocomposite. The coupling agent at the levels used must not significantly increase the haze or decrease luminous transmittance of the polymer composition.

The polymers do not increase the haze level in or reduce the luminous transmittance of the composition. Maleic anhydride is unsaturated in the ring making it easily reactive and which does not impart haze or reduced luminous transmittance in the composition. Maleic anhydride reacts without generating water as a byproduct which can contribute to haze and reduce luminous transmittance.

A preferred thermoplastic composition of the present invention is comprised of a crystalline polypropylene metallocene homopolymer with a melt flow index from 0.1 to 35 g/10 min. and ranging from 70 to 95% by weight; a plastomer with a melt flow between 0.1 and 5 grams/10 minutes, at about 0.1 to 10% by weight, a polymeric maleic anhydride coupling agent at about 0.5 to 5% by weight, and a nanocomposite comprising a surface modified montmorillonite at about 0.1 to 5% by weight wherein all weights are based on the weights of the total composition. Another preferred component in this composition is one or more nucleating/clarifying agents in an amount ranging from 0.1 to 0.5% by weight.

In another embodiment, the invention provides a method for recycling an automotive vehicle by manufacturing a first exterior component, securing it to an automotive vehicle, removing it after the life of the vehicle, grinding it, injection molding it into another second exterior component.

In particular:

Component 1: Metallocene based homopolymer polypropylenes are used in the invention. Metallocene catalyzed polypropylene homopolymers have excellent optical properties. The metallocene homopolymer polypropylene of choice has a very low haze level of 8-10% as measured by a 40 mil plaque in ASTM D-1003-95. The metallocene homopolymer polypropylene also has very low extractables of 1 to 1.5% as compared to another metallocene based polypropylene of the Ziegler-Nather catalyzed polypropylene which has 2 to 3% extractables. Another property of the preferred metallocene based polypropylene is a high HDT (heat deflection temperature) as measured by ASTM D648 of 225 F.

Another metallocene based polymer is an isotactic copolymer of polypropylene. Isotactic polymers (I-PP) tend to be more crystalline in nature, than for example the syndiotactic metallocene polymers (s-PP). The s-PP is more rubbery like and has a lower flex modulus than the Isotactic polypropylene polymers. The I-PP has a very low haze level as measured by ASTM D1003 test method. The I-PP has a gloss level of 95% as measured by ASTM D-2457.

Preferably the thermoplastic compositions are manufactured into exterior automotive components. This composition can also be manufactured into a body side molding/cladding. In automotive applications, the compositions must have excellent outdoor weathering characteristics. Exterior automotive components must meet OEM (original equipment manufacturing) standards for accelerated testing as tested to SAE J1960 and certain long term outdoor weathering in Florida and Arizona.

Metallocene-catalyzed polypropylenes are characterized by a narrow molecular weight distribution. Metallocene-catalyzed polyolefins also exhibit excellent optical clarity. Preferred sources of metallocene polypropylenes are ExxonMobil ACHIEVE polymers (Houston, Tex.)

The polypropylene is modified with a plastomer, coupling agents, and nanocomposites. The haze of the composition is less than 10%, and the transparency (luminous transmittance) is at least 80% without the pigments. The composition generally includes special effects pigments, such as aluminum flake or pearlescent pigments, preferably transparent pigments.

Component 2: The present invention provides a plastomer of ethylene and octene which when molded has high transparency and low haze when unpigmented, and when pigmented and molded can match a paint chip in gloss level and depth of color without the cost and warranty issues of painting. The molded product has excellent physical properties such as excellent outdoor weathering, flexibility, scratch resistance, impact strength, and good chemical resistance. The resulting copolymer. The preferred plastomer is Exact 0201 (Exxon Mobil, Houston, Tex.), a polypropylene-octene copolymer. The plastomers are described for instance in a Technical Paper by Yu, T., et al., May 6-10, 2001 by Exxon Mobil.

The thermoplastic composition, because of its high transparency and low haze value, can be color matched to a wide variety of paint chips including a metallic paint chip. The thermoplastic composition also provides a molded product with excellent scratch resistance as measured by the automobile industry standard “5-finger” scratch test. The molded product is comparable in scratch resistance to current two component polyurethane coatings which are difficult to prepare. The preferred molded product also has excellent outdoor weathering characteristics as tested to accelerated weathering Xenon J1960 specification. A very high gloss level of at least 90% measured by a gloss meter at a 60° angle can also be achieved and as high as 95% has been achieved with the molded products.

Component 3: The third component of this invention is a coupling agent. The coupling agent is a grafted polyolefin polymer of maleic anhydride. The coupling agent improves physical properties such as stiffness, elongation, impact strength, and flow.

In the molded product the coupling agent coats the nanocomposite particles and allows easier dispersion in and improved adhesion to the polypropylene matrix. The coupling agent of choice is from ExxonMobil known as EXXELOR 1020 at levels between 0.1 to 5.0%. This is a homopolymer polypropylene grafted with maleic anhydride with a high content of the maleic anhydride.

Component 4: Component four in the thermoplastic composition is the nanocomposite. With relatively low levels: (0.1 to 5%) as compared to regular filler levels of (20 to 30%) one can achieve significant gains in physical properties. Because of these low loadings, plastic compositions using nanocomposites can maintain low specific gravities, good flow characteristics, as well as high transparency (luminous transmittance) and low haze. Nanocomposites also promote rapid crystallization. The increase in crystallization decreases cycle time and improves surface hardness. At a 5% by weight loading of a nanocomposite physical properties can be improved. The nanocomposite is preferably a surface modified montmorillonite mineral. In terms of compounding, nanocomposites need higher shear in order to increase the exfoliation or aspect ratio. During the compounding stages, it was found that lower the compounding temperatures (˜20° C. lower in all stages) to maintain colorless pellets, which in turn increased the torque level or mechanical shear. Mechanical shear is defined as: to become fractured under a load due to sliding action (50% torque in the BUSS (Bazel, Switzerland). The nanocomposite composition ranged from 0.1 to 5% by weight. The optimum loading is 0.5 to 1.0% by weight. The preferred nanocomposites supplier is Nanocor, Inc. in Arlington Heights, Ill.

Component 5: The fifth component is the nucleating agent. Nucleating agents tend to give a higher degree of crystallinity to polymers, resulting in increased mechanical properties. Some of the mechanical properties that are improved include a harder surface; higher flex modulus and improved optical properties, just to name a few. The hardness of the surface is most important. The nucleating agent raises the crystallinity temperature and provides a faster seed crystal start. The chemical structure of the nucleating/clarifying agent which is preferred has the structure

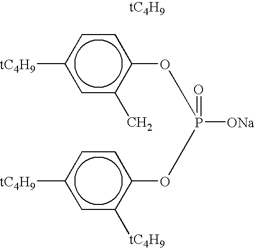

2,2′-methylenebis (4,6-di-tert-butylphenol) phosphate sodium salt (NA11 Amfine Chemical, Allendale, N.J.) As mentioned before, nucleating/clarifying agents give a higher degree of crystallinity to polymers, resulting in increased cycle times in an injection molding process. This is used at relatively low usage levels: 0.1 to 0.5% by weight. Preferably, the usage level is 0.4% parts by weight of the total composition.

Component 6: The next component in the plastic composition is preferably the UV package. The UV package has the function to protect the surface of the molded product from being degraded by UV light, in other words in outdoor exposure. The examples of parts to be protected from outdoor exposure can be automotive exterior.

UV absorbers, hindered amine light stabilizers, and antioxidants are used in the plastics industry to protect the finished molded parts from discoloring after exposure to UV sunlight. Typical loading levels are from 0.25% to 5% by weight. Examples of UV absorbers include benzophenones and benzotriazoles commercially available from a number of suppliers such as: BASF Corp., Mt. Olive, N.J., Ciba-Geigy Corp., Hawthorne, N.Y., and Witco Corp., Greenwich, Conn. Hindered amine light stabilizers are available commercially from Ciba-Geigy (Hawthorne, N.Y.) and Cytech. Antioxidants include alkylated phenols and bisphenols, alkylidene polyphenols, organic phosphites and phosphates.

Component 7: U.S. Pat. No. 6,017,989 describes the importance of many types of pigments. The pigments used may be inorganic or organic. Special effects pigments including flake alone or in conjunction with color pigments achieve special effects such as a metallic appearances. Inorganic types of pigments include, titanium dioxide, carbon black, red iron oxide, black iron oxide, chromium oxide green, ultramarine blue. Useful organic pigments are metallized and non-metallized azo reds, quinacridone reds, anthraquinone reds, perylene reds, copper phthalocyanine blues and greens isoindolineone oranges and yellows, carbazole violet, for instance. Inorganic and organic pigments are commercially available from many sources including BASF Corporation in Mt. Olive, N.J., Cabot Corporation, Billerica, Mass., Ciba-Geigy Corp. Newport, Del., and Mineral Pigments Corporation in Beltsville, Md.

Special effects pigments are metallic flake and pearlescent pigments including aluminums, micas, gold bronze, copper, nickel, brass, magnesium, and zinc. These types of special effect pigments are available from many sources such as Silberline, Tamacua, Penna, EM Industries, Hawthorne, N.Y. Micas are available from The Mearl Corporation, New York, N.Y., and EM Industries, Hawthorne, N.Y. The average particle size of the dispersed pigments, including the flake, is preferably less than one micron and more preferably less than 0.2 microns.

Color concentrates which include pigments and a carrier may be added in amounts of up to 14% by weight to the polymer composition, preferably between 4% and 10% by weight. Pigments are added in varying amounts to provide opacity. Pigments are dispersed in a carrier prior to being introduced into the polymer blend. Such carriers are typically high molecular weight polyethylene or polypropylene.

Heat and pressure are applied to the polymer compositions using various methods of processing can be applied such as thermoforming, extrusion, injection molding, and compression molding. The polymer compositions are formulated to have a wide range of melt flows to accommodate various processes, a wide range meaning from 2.0 to 35 g/10 min. as measured by ISO 1133. The polymer composition can be injection molded into automobile exterior parts such as, but not limited to, body side moldings, claddings, ground effects, mirror housings, spoilers, and A,B,C, pillars on the interior.

Automotive exterior components are particularly suitable for the recycling process due to the compatible nature of the polypropylenes. In terms of the steps to recycle such component, the component is removed from the vehicle, fed through a shredder and ground up into “fines” or “particulates”. The fines may be added to other thermoplastic polyolefins (TPO) and reshaped through the injection molding process. The molded product can also be removed from the vehicle, shredded and ground up into “fines” and reshaped through the injection molding process without breaking down or affecting the metallic or pearlescent pigments.

The compositions of the present invention are scratch resistant per Chrysler specification LP-463DD18-01. A sample shall be scratched by a 1 mm pin: 1 pass by the following force in newtons:

2N

3N

4.5N

6N

7N

*Note: Samples shall be evaluated with a rating of 1 through 5,

1=no scratch

5=severe scratch line.

Maximum allowed scratch severity—rating of 2 for 7N force. The preferred composition had a rating of 2 for a 7N force, and the ability to remove scratches and mars with car polish is noteworthy. With the products of the present invention even small scratches can be easily removed with conventional automotive polish containing a very fine grit abrasive. There is an advantage over a painted clear coat since the pigment is throughout the molded product.

### EXAMPLE 1

The following materials are weighed into a mixer: 92.9 parts ACHIEVE™ 1635E1 (a metallocene-catalyzed polypropylene homopolymer available from ExxonMobil Chemical); 4.5 parts EXACT 0201 (an ethylene and octene copolymer impact modifier available from ExxonMobil Chemical); 1 part EXXELOR PO 1020 (a coupling agent available from ExxonMobil Chemical); 0.5 parts Nanocor 130 (a surface modified montmorillonite mineral filler available from Nanocor); 0.4 parts AMFINE NA-11 (a stabilizing nucleating agent available from Amfine Chemical Corp.); 0.2 parts CYASORB UV-2337 (UV light absorber available from Cytec Industries); 0.2 parts CYASORB UV-3529 (light stabilizer available from Cytec Industries); 0.2 parts CYASORB UV-3853 (light stabilizer available from Cytec Industries); 0.05 parts CYANOX 1741 (antioxidant available from Cytec Industries); and 0.05 parts DOVERPHOS S-9228 (antioxidant available from Dover Chemical Corp.). The above mixture was tumbled in a 55 pound drum, and fed into a BUSS Kneader corresponding extruder. The extrudate is cooled into a water trough and pelletized.

The pellet color/powder mix was then batch fed into one feeder into a 46 mm BUSS Kneader (Bazel, Switzerland) compounding extruder. The BUSS Kneader was set up as follows: zone 1: 175-155° C., zone 2: 180-160° C., zone 3: 185-165° C., zone 4: 190°-170° C. The torque reader was at 50%. The materials melted together, and produced high transparent, low haze extrudate. The extrudate was cooled by a water trough and then the strands were pelletized at a rate of 75 lbs/Hr.

Material Properties: The following physical properties prior to mixing with the color were obtained:

a) Transparency of at least 80% as measured by ASTM D1003

b) Haze value less than 10% as measured by ASTM D1003

c) High Gloss reading of 95% as measured by a gloss meter

d) Excellent scratch resistance of a rating of 2 (visible line) using a 1 mm pin and a 7 N force tested to the Abrasion Resistance Spec: LP-463PB-54-01

e) Excellent chemical resistance with a DE<1.0 tested to MS-JP9-8

f) Excellent UV protection a DE reading of <1.0 tested to SAE J1960 (xenon arc weatherometer).

g) Excellent static weathering in Arizona and Florida and a DE reading of less than 1.

### EXAMPLE 2

Another preferred uncolored formulation was:

| RM | % by Weight |
|---|---|
| ExxonMobil Achieve 1635 | 93.1 |
| ExxonMobil Exact 0201 | 4.5 |
| ExxonMobil EXXELOR 1020 | 1.0 |
| Nanocor I 30 | 0.5 |
| AMFINE NA-11 | 0.4 |
| CYTECH 1741 | 0.05 |
| CYTECH CEC 7001 | 0.40 |
| DOVERPHOS 9228 (Dover | 0.05 |
| Chemical, Dover, Ohio) | |
| | 100% |

### EXAMPLE 3

The colors used were from Americhem, Cuyahoga Falls, Ohio. All produced an excellent color with significant depth. The colors blended were:

Ford:

Dark Satin Green

GM:

Pewter Metallic

Red Tint

Gray Metallic

Chrysler:

Jet black

Brilliant black

Bright white

Flame red

Light almond

Magnesium

Timberline green

Midnight blue

Bright silver metallic

Processing: The transparent/low haze polymer composition blend is used at 25 parts to 1 part of the silver frost color concentrate. The two components, transparent/low haze polymer composition and the color concentrate pellet are then blended together and then introduced into an injection molding machine which would have the following profile: zone 1: 410° F. (210° C.), zone 2: 420° F. (216° C.), zone 3: 430° F. (221° C.), zone 4: 440° F. (227° C.), nozzle temperature: 450° F. (227° C). To achieve a highly glossy surface, the mold should have a very high quality steel and be polished up to an A-3 level. The mold temperature should be 90-100° F. (32 to 38° C.). The cycle time has been 90 seconds.

The following Examples 3 and 4 show different amounts of the ingredients which produced similar results.

| RM | % by Weight |
|---|---|
| ACHIEVE 1635 | 87.6 |
| EXACT 0201 | 10 (10% by weight) |
| EXXELOR PO 1020 | 1.0 |
| NANOCOR I 30 | 0.5 |
| AMFINE NA-11 | 0.4 |
| CYTECH 1741 | 0.05 |
| CYTECH CEC 7001 | 0.40 |
| DOVERPHOS 9228 | 0.05 |

This product had good surface properties.

| RM | % by Weight |
|---|---|
| ACHIEVE 1635 | 92.9 |
| EXACT 0201 | 4.5 |
| EXXELOR PO 1020 | 1.0 |
| NANOCOR I 30P | 0.5 |
| AMFINE NA-11 | 0.4 |
| CYTECH 2337 | 0.20 |
| CYTECH 3529 | 0.20 |
| CYTECH 3853P | 0.20 |
| CYTECH 1741 | 0.05 |
| CYTECH 641 | 0.05 |
| | 100% |

The product had good surface properties.

The present invention provides:

1. An exterior automotive vehicle component comprising a plastomer modified polypropylene having a haze level of less than about 10% and a transmission (luminous transmittance) of at least 80% with special effects pigments uniformly distributed therein.

2. The exterior automotive vehicle component when secured next to a painted surface of an automobile significantly color matches that painted surface.

3. A method of recycling an exterior automotive vehicle component as previously described which comprises:

securing an exterior bodyside cladding component of an automotive vehicle;

removing the exterior bodyside cladding component from the automotive vehicle;

grinding the exterior bodyside cladding to “fines”; and

re-forming the “fines” into another shape by injection molding

It is intended that the foregoing description be only illustrative of the present invention and that the present invention be limited only by the hereinafter appended claims.

I claim:

1. A thermoplastic composition substantially free of elastomers which comprises in admixture:
(a) a crystalline polypropylene homopolymer having a haze of less than about 10% and a luminous transmittance of at least about 80% as measured by ASTM D1003 95;
(b) a thermoplastic plastomer which is a linear copolymer of ethylene and an octene monomer wherein a plastomer is present in an amount between about 1 and 10 percent by weight of the polypropylene;
(c) an exfoliated layered inorganic nanocomposite derived from a precursor nanocomposite with nanolayers and galleries between the nanolayers wherein the nanocomposite is present in an amount between about 0.1 and 6% by weight of the composition, wherein the nanocomposite has been exfoliated by (a), (b) or a mixture of (a) and (b);
(d) a coupling agent which is a polyolefin polymer grafted to maleic anhydride and which couples (a), (b) and (c) together in an amount up to about 10% by weight of the composition, wherein the composition when molded without pigments has at least the haze and the luminous transmittance of the polypropylene.

2. The composition of claim 1 containing a color pigment.

3. The composition of claim 2 as a molded product.

4. The composition of claim 2 as a body part for a vehicle.

5. The composition of claim 2 as a body part for a vehicle which duplicates a paint color of the vehicle.

6. The composition of claim 2 wherein the precursor nanocomposite contains an exfoliating agent which is an organic onium ion for exfoliation by (a) and (b).

7. The composition of claim 2 wherein the nanocomposite has a particle size of between about 1 and 100 microns.

8. The composition of claim 2 which is as pellets formable into a molded product.

9. The composition of claim 1 wherein the precursor nanocomposite is a 2:1 layered silicate with a particle size between about 1 and 100 nanometers containing an organic quaternary ammonium ion between the layers.

10. The composition of any one of claim 2 wherein the plastomer is present in an amount less than ten percent (10%) by weight of the composition.

11. A method for the preparation of a molded part which comprises:
(a) providing a thermoplastic composition substantially free of elastomers which comprises in admixture:
(i) a crystalline polypropylene homopolymer having a haze of less than about 10% and a luminous transmittance of at least about 80% as measured by ASTM D1003 95;
(ii) a thermoplastic plastomer which is a copolymer of ethylene and an octene monomer in an amount between about 1 and 10 percent by weight of the polypropylene;
(iii) an exfoliated layered inorganic nanocomposite derived from a precursor nanocomposite with nanolayers and galleries between the nanolayers in an amount between about 0.1 and 6% by weight of the composition, wherein the nanocomposite has been exfoliated by (a), (b) or a mixture of (a) and (b); and
(iv) a coupling agent which is a polyolefin polymer grafted to maleic anhydride which couples (a), (b) and (c) together which is present in an amount up to about 10% by weight of the composition, wherein the composition when molded without pigments has at least the haze and the luminous transmittance of the polypropylene; and
(b) forming the molded part, wherein the part without a color pigment has the haze of less than 10% and the luminous transmittance of at least about 80%.

12. The method of claim 11 wherein the composition contains a color pigment.

13. The method of claim 12 wherein the composition in step (a) has been mixed in an extruder and then injection molded as a molded product.

14. The method of claim 12 wherein the composition in step (a) is mixed in an extruder, cut into pellets and then injection molded as an article.

15. A recyclable composition which comprises:
a particulate material from a molded product of the thermoplastic composition of claim 1 which has been ground to provide the composition.

16. A method of recycling a polypropylene composition which comprises:
(a) providing a first molded product of a thermoplastic composition of claim 1;
(b) grinding the molded product to a particulate material; and
(c) molding the particulate material into a second molded product.

17. The composition of claim 1 wherein a nucleating agent is provided in the composition to provide crystallinity in the polypropylene when the composition is molded.

18. The method of claim 11 wherein a nucleating agent is provided in the composition to promote crystallinity in the polypropylene when the composition is molded.

19. The composition of claim 15 wherein nucleating agent is provided in the composition to promote crystallinity in the polypropylene wherein the composition is molded.

20. The composition of any one of claim 17 wherein the nucleating agent is di(tetratertiary butylphenyl) phosphate in an amount between 0.1 and 1.0 percent by weight of the composition.

21. A method for forming a thermoplastic composition which comprises:
(a) blending of a mixture
(i) a crystalline polypropylene homopolymer having a haze of less than about 10% and a luminous transmittance of at least about 80% as measured by ASTM D1003 95;
(ii) a thermoplastic plastomer which is a copolymer of ethylene and octene in an amount between about 1 and 10 percent by weight of the polypropylene;
(iii) a coupling agent which is a polyolef in polymer grafted to maleic anhydride which couples (a), (b) and (c) together which is present in an amount up to about 10% by weight of the composition, wherein the composition when molded without pigments has at least the haze and the luminous transmittance of the polypropylene; with a precursor nanocomposite so that the precursor nanocomposite is exfoliated in a mixture of (i), (ii) and (iii); and
(b) extruding the mixture with the exfoliated nanocomposite and cutting the extrudate to form pellets.

22. The method of claim 21 wherein the nanocomposite is a 2:1 layered silicate.

23. The method of any one of claim 21 wherein in addition after step (b) the composition is mixed with a color pigment for injection molding.
